(19) United States
(12) Patent Application Publication
(10) Pub. No.: US 2018/0084333 A1
(43) Pub. Date: Mar. 22, 2018

(54) Speakerless Headset Apparatus

(71) Applicants: Amanda Anderson, Laguna Beach, CA (US); David Schwind, Rocklin, CA (US)

(72) Inventors: Amanda Anderson, Laguna Beach, CA (US); David Schwind, Rocklin, CA (US)

(21) Appl. No.: 15/713,280

(22) Filed: Sep. 22, 2017

Related U.S. Application Data
(60) Provisional application No. 62/398,306, filed on Sep. 22, 2016.

(51) Int. Cl. H04R 1/10

(52) U.S. Cl. CPC H04R 1/1091; H04R 2420/07

(57) ABSTRACT

A speakerless headset apparatus has a first earpiece and a second earpiece, each earpiece configured to rest on, or over, the ear of a user. Each earpiece is coupled to a respective sound conduit (i.e., the first earpiece is coupled to a first sound conduit). Each conduit is removably coupleable to one or more speaker housings, the speaker housing having one or more speakers for outputting audio received from an audio device. The one or more speakers electrically coupled to an audio output device.

### CROSS-REFERENCE TO RELATED APPLICATIONS

This application claims the benefit of U.S. Provisional Application Ser. No. 62/398,306, filed on Sep. 22, 2016, which is incorporated herein by reference in its entirety.

### TECHNICAL FIELD

The present disclosure relates to headphones and earbuds. More particularly, the present disclosure relates to speakerless headphones and earbuds to reduce or eliminate radiation exposure.

### BACKGROUND

The use of headphones (resting on, or placed over, the ear) and earbuds (i.e., insertable into the ear opening), collectively described herein as “headsets,” are used extensively throughout the world. Because these components are largely electric, users of these items experience a large, documented increase in radiation exposure. High radiation exposure can lead to cancer and other serious health concerns. As a result, there is a need to reduce radiation, while still allowing a user to enjoy the use of headsets.

The prior art has attempted to solve this problem by creating speakerless earbuds coupled to a sound conduit. In other words, a user plugs a headphone jack into a device for playing audio, the electric signal is received by one or more speakers coupled thereto, the speakers being encased and coupled to one or more conduits for transmitting sound to a user's ears. While the prior art has been able to produce earbuds, they have failed at producing a speakerless headphone that utilizes sound conduits to transmit sound. Further, the prior art's attempt at creating speakerless earbuds has failed, in part, due to the configuration of components in those earbuds. As such, there remains a need for a speakerless earbud that is cost effective, durable, and that still provides for excellent sound quality. The present invention seeks to solve these and other problems.

### SUMMARY OF EXAMPLE EMBODIMENTS

In one embodiment, a speakerless headphone apparatus comprises a first earpiece and a second earpiece, each earpiece configured to rest on, or over, the ear of a user. Each earpiece is coupled to a respective sound conduit (i.e., the first earpiece is coupled to a first sound conduit). Each conduit is removably coupleable to one or more speaker housings, the speaker housing comprising one or more speakers for outputting audio received from an audio device. The one or more speakers electrically coupled to an audio output device.

In one embodiment, an on-the-ear or over-the-ear headphone comprises an external sound port, the port being operable by a user by the manipulation of a port cover.

In one embodiment, the speaker housings may be of varying sizes, allowing a user to choose the type of sound they hear. The use of removably attachable sound conduits allows a user to select and customize the speakers to his/her preferences.

In one embodiment, at least one speaker housing is coupled to a wireless receiver (e.g., Bluetooth®). The wireless receiver is configured to receive sound from an audio output device, wherein the signal is transmitted to the speaker, the sound then passing through the one or more sound conduits to a user's ears via the headset.

### BRIEF DESCRIPTION OF THE DRAWINGS

FIG. 1 is a side elevation view of a speakerless headset apparatus;

FIG. 2 is a bottom perspective view of a speakerless headset apparatus;

FIG. 3 is a detailed view of a speaker housing of a speakerless headset apparatus;

FIG. 4 is a front view of a speakerless headset apparatus; and

FIG. 5 is a detailed view of a sound port of a speakerless headset apparatus.

### DETAILED DESCRIPTION OF EXAMPLE EMBODIMENTS

The following descriptions depict only example embodiments and are not to be considered limiting in scope. Any reference herein to “the invention” is not intended to restrict or limit the invention to exact features or steps of any one or more of the exemplary embodiments disclosed in the present specification. References to “one embodiment,” “an embodiment,” “various embodiments,” and the like, may indicate that the embodiment(s) so described may include a particular feature, structure, or characteristic, but not every embodiment necessarily includes the particular feature, structure, or characteristic. Further, repeated use of the phrase “in one embodiment,” or “in an embodiment,” do not necessarily refer to the same embodiment, although they may.

Reference to the drawings is done throughout the disclosure using various numbers. The numbers used are for the convenience of the drafter only and the absence of numbers in an apparent sequence should not be considered limiting and does not imply that additional parts of that particular embodiment exist. Numbering patterns from one embodiment to the other need not imply that each embodiment has similar parts, although it may.

Accordingly, the particular arrangements disclosed are meant to be illustrative only and not limiting as to the scope of the invention, which is to be given the full breadth of the appended claims and any and all equivalents thereof. Although specific terms are employed herein, they are used in a generic and descriptive sense only and not for purposes of limitation. Unless otherwise expressly defined herein, such terms are intended to be given their broad, ordinary, and customary meaning not inconsistent with that applicable in the relevant industry and without restriction to any specific embodiment hereinafter described. As used herein, the article “a” is intended to include one or more items. When used herein to join a list of items, the term “or” denotes at least one of the items, but does not exclude a plurality of items of the list. For exemplary methods or processes, the sequence and/or arrangement of steps described herein are illustrative and not restrictive.

It should be understood that the steps of any such processes or methods are not limited to being carried out in any particular sequence, arrangement, or with any particular graphics or interface. Indeed, the steps of the disclosed processes or methods generally may be carried out in various different sequences and arrangements while still falling within the scope of the present invention.

The term “coupled” may mean that two or more elements are in direct physical contact. However, “coupled” may also mean that two or more elements are not in direct contact with each other, but yet still cooperate or interact with each other.

The terms “comprising,” “including,” “having,” and the like, as used with respect to embodiments, are synonymous, and are generally intended as “open” terms (e.g., the term “including” should be interpreted as “including, but not limited to,” the term “having” should be interpreted as “having at least,” the term “includes” should be interpreted as “includes, but is not limited to,” etc.).

As will be appreciated from this disclosure, a speakerless headphone apparatus solves the problem of sound quality, comfort, and flexibility not found in earbuds. Further, it will likewise be appreciated that speakerless earbuds, as disclosed herein, are superior to those currently known in the art in that they provide better quality sound transmission, greater flexibility to a user, are more durable, and are still economic.

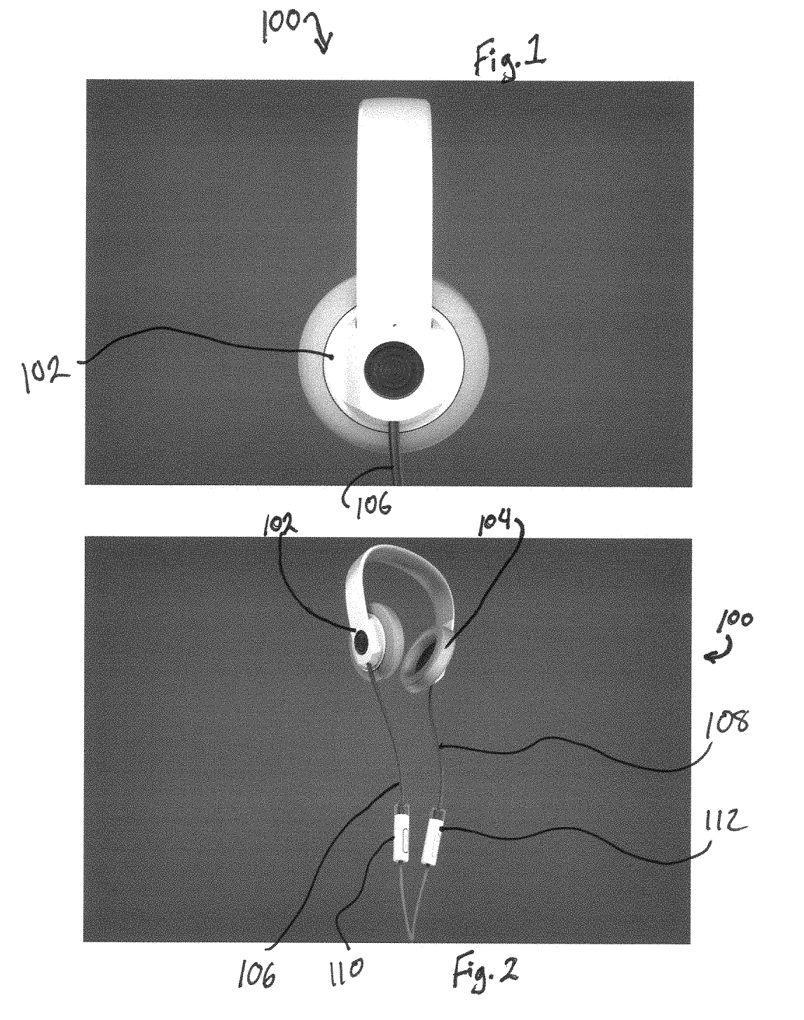

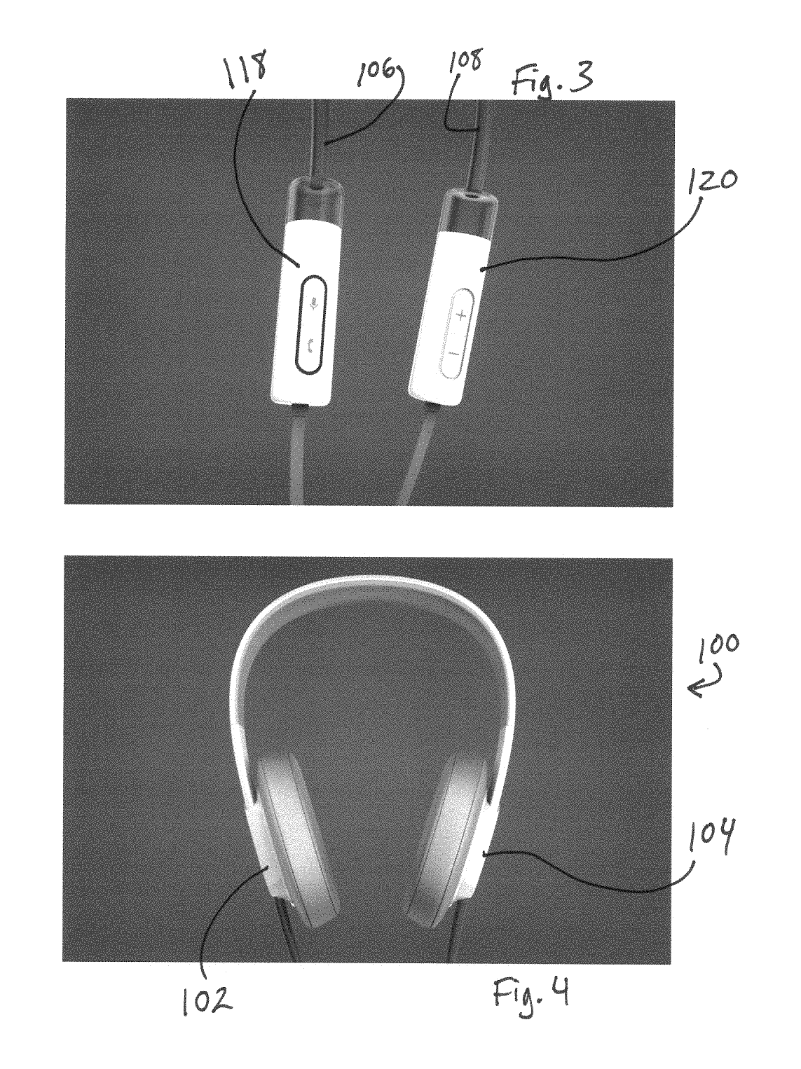

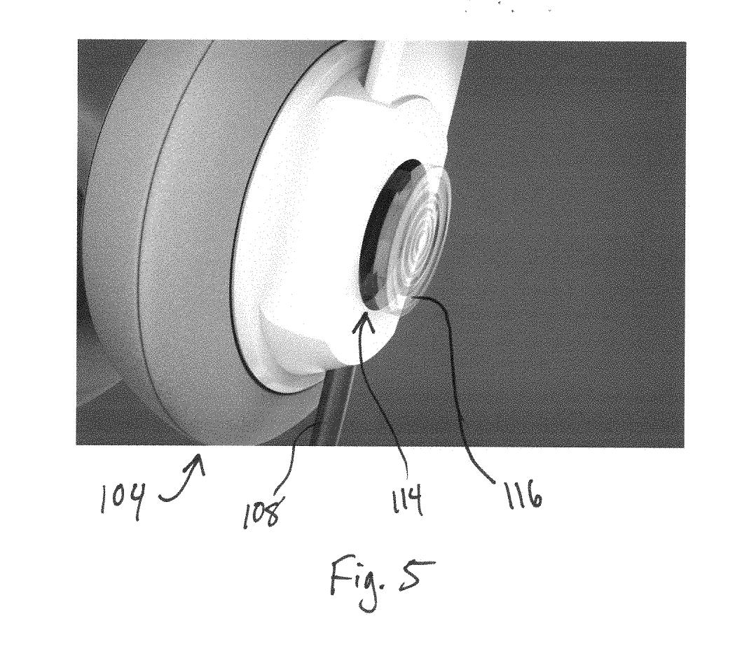

In one embodiment, as shown in FIGS. 1-5, a speakerless headphone apparatus 100 comprises a first earpiece 102 and a second earpiece 104, each earpiece 102, 104 configured to rest on, or over, the ear of a user. It will be appreciated that standard comfort elements known in the art of headphones are incorporated herein, such as comfort padding to ease any pressure on a user's ears or head, etc. Each earpiece is coupled to a respective sound conduit (i.e., the first earpiece 102 is coupled to a first sound conduit 106 and the second earpiece 104 is coupled to a second sound conduit 108). The sound conduit may be manufactured from a variety of materials, including, but not limited to, silicones, rubbers, flexible plastics, and other similar materials capable of transmitting sound therein. In one embodiment, each conduit is removably coupleable to one or more speaker housings 110, 112, the speaker housings 110, 112 comprising one or more speakers for outputting audio received from an audio device. The one or more speakers electrically coupled to an audio output device. It will be appreciated that an alternative embodiment may only have one earpiece—two earpieces (i.e., one for each ear) is not required.

There are several benefits to allowing the sound conduit to be removably attachable to the speaker box; for example, a user may replace worn out or broken components more easily; or, a user may customize the components for his/her liking. In other words, a user desiring a more robust sound may plug his sound conduits into a speaker housing comprising larger speakers. Further, as will be described in better detail later on, it also allows a user to use the speakerless headset (as used herein, a “headset” refers to both a headphone or earbud) with other accessories, such as a Bluetooth® receiver, for example. While there are many benefits from having a removably coupleable sound conduit, it is not required that they be removable. In other words, in one embodiment, the sound conduits may be non-removable by a user. Further, even when the conduits are non-removable, various sizes of speakers may be used inside the speaker housing. Currently in the art, speaker housings are less than about 0.5 inches wide, which prohibits the use of high-quality speakers having a diameter equally as large. As such, in one embodiment, the speaker housing is greater than 0.5 inches wide so as to be able to contain a speaker therein of complementary size. In other words, a wider housing may contain a larger diameter speaker. While having a housing be larger than 0.5 inches may be beneficial, it is not required. Therefore, in another embodiment, the speaker housing is less than about 0.5 inches wide. Further, it will be appreciated that a speaker housing may also refer to a speaker inserted inside a sound conduit (“inline”) and does not necessarily require a separate housing.

In one embodiment, as shown in FIG. 2, each sound conduit 106, 108 is coupled to a separate speaker housing 110, 112, each housing 110, 112 configured to receive distinct signals for outputting stereo sound to a user. In another embodiment, each sound conduit is coupled to a single speaker housing containing two or more speakers for outputting stereo sound. In another embodiment, each conduit is coupled to a speaker housing comprising only one speaker for mono sound output. In yet another embodiment, each conduit is coupled to a distinct speaker housing, the speaker housings being removably coupleable to each other using a variety of means, such as magnets, hooks and loops (e.g., Velcro®), snaps, straps, etc. This configuration allows for maximum sound quality by keeping the speakers isolated from one another, but allows a user to enjoy physical activities, such as running, without the two speaker housings constantly colliding one with another.

In one embodiment, an on-the-ear or over-the-ear headphone comprises an external sound port 114, the port being operable by a user by the manipulation of a port cover 116. In other words, a disadvantage of all headsets in the market is that a user cannot hear external sounds, including their own voice, without removing at least one headset from an ear. For example, a user who desires to use the headset as a hands-free calling device must generally remove at least one audio device from an ear in order to hear themselves speak without being muffled. In another scenario, a user may wish to listen to another person, or to an overhead announcement, without removing the entire headset. Currently, a user must remove at least one headset piece. To alleviate this problem, the headphone described herein has a port cover 116 that may be opened (such as by rotation, hinged opening, sliding, push-release, or equivalent), allowing sound to pass through one or more apertures (for example, vents) leading to the user's ear. Of note, the one or more apertures may still be protected, such as by using a vent-like system, netlike system, or similar. This allows a user to quickly and easily listen to external sounds without the need of removing any portion of the headphone from the user's ears. Such port 114 and port cover 116 may be on one or both of the earpieces 102, 104 of the headphone apparatus 100. In one embodiment, the port cover may likewise block sound incoming from the sound conduit when opened for external sounds. For example, the port cover may slide downward and penetrate inwards, where it seals the sound from the conduit while simultaneously opening the aperture to external sounds. Another embodiment may use rotational dials using one or more gears that open and close the sound passages. Other configurations achieving the same result are likewise contemplated.

As mentioned earlier, the speaker housings may be of varying sizes, allowing a user to choose the type of sound they hear. The use of removably attachable sound conduits allows a user to select and customize the speakers to his/her preferences, which is a marked improvement over the prior art. However, again, while removably attachable conduits are beneficial, they are not required.

In one embodiment, an inline microphone 118 is coupled to the wire leading to the speakers from the audio output device. It will be appreciated that an audio output device may be a phone, where it would be desirable for a user to have a microphone for making hands-free calls. The microphone 118 may be coupled to one or more controls 120, such as answer/hang-up, hold, volume, etc. Further, the microphone may be configured separately from the speaker housings, allowing a user to customize the speakers or microphone independently of the other, should a user desire. For example, users who frequently use hands-free calling may desire to have a larger, higher-quality microphone than a standard user. As such, a user may easily couple a higher quality microphone to the speaker housing, the speaker housing coupled to one or more sound conduits for transmitting sound to a user's ears. The ability to couple a higher-quality microphone is also a marked improvement over the prior art.

As briefly mentioned earlier, the use of wireless headsets is increasing. As such, in one embodiment, at least one speaker housing is coupled to a wireless receiver (e.g., Bluetooth®). The wireless receiver is configured to receive sound from an audio output device, wherein the signal is transmitted to the speaker, the sound then passing through the one or more sound conduits to a user's ears via the headset. In one embodiment, the wireless receiver and speaker housing are one unit. In other words, one housing encompasses both the wireless receiver and the speaker(s), without one being separable from the other. The sound conduits would still ideally be removably coupleable thereto, allowing a user to continue to use the headset with varying configurations (e.g., with a wireless device or with a wired device). In an alternative configuration, the wireless device and the speaker housing are separate. In this configuration, the speakers may be coupled to the wireless receiver using a standard audio jack, or may be wired directly thereto.

Exemplary embodiments are described above. No element, act, or instruction used in this description should be construed as important, necessary, critical, or essential unless explicitly described as such. Although only a few of the exemplary embodiments have been described in detail herein, those skilled in the art will readily appreciate that many modifications are possible in these exemplary embodiments without materially departing from the novel teachings and advantages herein. Accordingly, all such modifications are intended to be included within the scope of this invention.

What is claimed is:

1. A speakerless headphone apparatus, comprising:
a first earpiece and a second earpiece, each earpiece configured to rest over the ear of a user;
a speaker housing comprising one or more speakers;
a first conduit for coupling the first earpiece to the speaker housing and a second conduit for coupling the second earpiece to the speaker housing;

2. The speakerless headphone apparatus of claim 1, further comprising two speaker housings and wherein the first conduit is coupled to the first housing and the second conduit is coupled to the second housing.

3. The speakerless headphone apparatus of claim 1, wherein each earpiece further comprises an external sound port.

4. The speakerless headphone apparatus of claim 3, wherein the external sound port comprises a port cover that is selectively opened or closed by user manipulation.

5. The speakerless headphone apparatus of claim 1, wherein the speaker housing comprises a wireless receiver for receiving wireless audio signals.
